(19) United States
(12) Patent Application Publication
(10) Pub. No.: US 2023/0361848 A1
(43) Pub. Date: Nov. 9, 2023

(54) USER EQUIPMENT BEAM RECONFIGURATION PROCEDURE TRIGGERING

(71) Applicant: NOKIA TECHNOLOGIES OY, Espoo (FI)

(72) Inventors: Samantha CAPORAL DEL BARRIO, Aalborg (DK); Simon SVENDSEN, Aalborg (DK); Johannes HARREBEK, Aalborg (DK); Kim NIELSEN, Storvorde (DK)

(73) Assignee: NOKIA TECHNOLOGIES OY, Espoo (FR)

(21) Appl. No.: 18/004,913

(22) PCT Filed: Jul. 8, 2021
(86) PCT No.: PCT/EP2021/069085

§ 371 Date: Jan. 10, 2023

(30) Foreign Application Priority Data
Jul. 10, 2020 (FI) 20205747

(51) Int. Cl. H04B 7/06; H04B 7/08

(52) U.S. Cl. CPC H04B 7/06952; H04B 7/088

(57) ABSTRACT

A method and apparatus for triggering a user equipment beam reconfiguration procedure are disclosed. The method comprises: receiving, at a user equipment, channel parameters relating an uplink channel and a downlink channel; determining, at the user equipment, from the channel parameters whether there is a mismatch in uplink channel and downlink channel performance and, if so; triggering, at the user equipment, a user equipment beam reconfiguration procedure.

### TECHNOLOGICAL FIELD

Various example embodiments relate to a method and apparatus for triggering a user equipment beam reconfiguration procedure.

### BACKGROUND

In a wireless telecommunications network, such as a 5G network, uplink and downlink beams are formed between user equipment and a network node to support communication between the user equipment and the network node. Although techniques exist for configuring those uplink and downlink beams, poor communication performance between the user equipment and the network node can occur. Accordingly, it is desired to provide an improved technique for supporting communication between the user equipment and the network node.

### BRIEF SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to various, but not necessarily all, embodiments of the invention there is provided a method, comprising: receiving, at a user equipment, channel parameters relating an uplink channel and a downlink channel; determining, at the user equipment, from the channel parameters whether there is a mismatch in uplink channel and downlink channel performance and, if so; triggering, at the user equipment, a user equipment beam reconfiguration procedure.

The triggering may comprise triggering, at the user equipment, at least one of an uplink beam and a downlink beam reconfiguration and an uplink beam and a downlink beam realignment procedure.

The at least one channel parameter may comprise an indication of an uplink channel reconfiguration.

The at least one channel parameter may comprise an indication of a downlink channel performance.

The determining may comprise determining that there is the mismatch when the channel parameters indicate a request to reconfigure the uplink channel to increase performance of the uplink channel in an absence of an indication of a corresponding decrease in performance of the downlink channel.

The determining may comprise determining that there is the mismatch when the channel parameters indicate the request to reconfigure the uplink channel to increase performance of the uplink channel by a first amount in the absence of the indication of the corresponding decrease in performance of the downlink channel by at least the first amount.

The determining may comprise determining that there is the mismatch when the channel parameters indicate the request to reconfigure the uplink channel to increase performance of the uplink channel by the first amount in the absence of the indication of the corresponding decrease in performance of the downlink channel by a threshold amount greater than the first amount.

The method may comprise varying the threshold amount based on uplink channel reconfigurations made by the user equipment.

The method may comprise receiving an indication of the threshold amount from a network node.

The determining may comprise determining that there is the mismatch when the channel parameters indicate the request to reconfigure the uplink channel to increase performance of the uplink channel by the first amount in the absence of the indication of the corresponding decrease in performance of the downlink channel by greater than the first amount over a period of time.

The period of time may be indicated by at least one of a counter, a timer and a number of transmission frames.

The method may comprise receiving an indication of the period of time from a network node.

The request to reconfigure the uplink channel may comprise at least one of a request to increase an uplink transmission power and a request change to an uplink modulation scheme.

The indication of the downlink channel performance may comprise an indication of at least one of a downlink signal strength, a downlink signal power, a downlink signal quality, a downlink channel quality and a downlink rank indicator.

The method may comprise preventing the triggering during at least one of an uplink and a downlink reconfiguration procedure.

The method may comprise preventing the triggering during a user equipment initial access procedure.

The method may comprise preventing the triggering during an open loop power control procedure.

The method may comprise preventing the triggering prior to completing a user equipment beam alignment procedure.

The method may comprise preventing the triggering prior to completing a P3 beam alignment procedure.

The uplink beam and downlink beam realignment procedure may comprise at least one of a beam correspondence evaluation procedure and an array reconfiguration.

The method may comprise preventing, at a network node, triggering of the beam correspondence evaluation procedure when the mismatch in uplink channel and downlink channel performance is expected.

The method may be a user equipment method and/or performed at a user equipment.

According to various, but not necessarily all, embodiments of the invention there is provided a computer program comprising instructions for causing an apparatus to perform at least the following: receiving, at said apparatus comprising a user equipment, channel parameters relating an uplink channel and a downlink channel; determining, at the user equipment, from the channel parameters whether there is a mismatch in uplink channel and downlink channel performance and, if so; triggering, at the user equipment, a user equipment beam reconfiguration procedure.

The computer program may comprise instructions for causing an apparatus to perform the method set out above.

According to various, but not necessarily all, embodiments of the invention there is provided an apparatus, comprising: means for receiving, at said apparatus comprising a user equipment, channel parameters relating an uplink channel and a downlink channel; means for determining, at the user equipment, from the channel parameters whether there is a mismatch in uplink channel and downlink channel performance and; means for triggering, at the user equipment, a user equipment beam reconfiguration procedure responsive to the means for determining the mismatch.

The means for triggering may trigger, at the user equipment, at least one of an uplink beam and a downlink beam reconfiguration and an uplink beam and a downlink beam realignment procedure.

The at least one channel parameter may comprise an indication of an uplink channel reconfiguration.

The at least one channel parameter may comprise an indication of a downlink channel performance.

The means for determining may determine that there is the mismatch when the channel parameters indicate a request to reconfigure the uplink channel to increase performance of the uplink channel in an absence of an indication of a corresponding decrease in performance of the downlink channel.

The means for determining may determine that there is the mismatch when the channel parameters indicate the request to reconfigure the uplink channel to increase performance of the uplink channel by a first amount in the absence of the indication of the corresponding decrease in performance of the downlink channel by at least the first amount.

The means for determining may determine that there is the mismatch when the channel parameters indicate the request to reconfigure the uplink channel to increase performance of the uplink channel by the first amount in the absence of the indication of the corresponding decrease in performance of the downlink channel by a threshold amount greater than the first amount.

The apparatus may comprise means for varying the threshold amount based on uplink channel reconfigurations made by the user equipment.

The apparatus may comprise means for receiving an indication of the threshold amount from a network node.

The means for determining may determine that there is the mismatch when the channel parameters indicate the request to reconfigure the uplink channel to increase performance of the uplink channel by the first amount in the absence of the indication of the corresponding decrease in performance of the downlink channel by greater than the first amount over a period of time.

The period of time may be indicated by at least one of a counter, a timer and a number of transmission frames.

The apparatus may comprise means for receiving an indication of the period of time from a network node.

The request to reconfigure the uplink channel may comprise at least one of a request to increase an uplink transmission power and a request change to an uplink modulation scheme.

The indication of the downlink channel performance may comprise an indication of at least one of a downlink signal strength, a downlink signal power, a downlink signal quality, a downlink channel quality and a downlink rank indicator.

The apparatus may comprise means for preventing the triggering during at least one of an uplink and a downlink reconfiguration procedure.

The apparatus may comprise means for preventing the triggering during a user equipment initial access procedure.

The apparatus may comprise means for preventing the triggering during an open loop power control procedure.

The apparatus may comprise means for preventing the triggering prior to completing a user equipment beam alignment procedure.

The apparatus may comprise means for preventing the triggering prior to completing a P3 beam alignment procedure.

The uplink beam and downlink beam realignment procedure may comprise at least one of a beam correspondence evaluation procedure and an array reconfiguration.

The apparatus may comprise means for preventing, at a network node, triggering of the beam correspondence evaluation procedure when the mismatch in uplink channel and downlink channel performance is expected.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

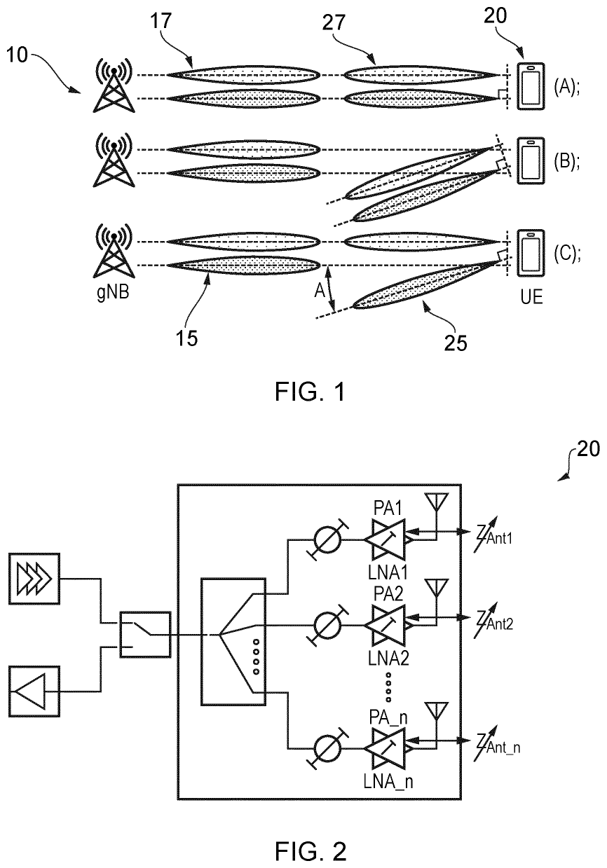

FIGS. 1A, 1B and 1C illustrate uplink/downlink beam correspondence and misalignment;

FIG. 2 is a transmit and receive simplified block diagram of the user equipment;

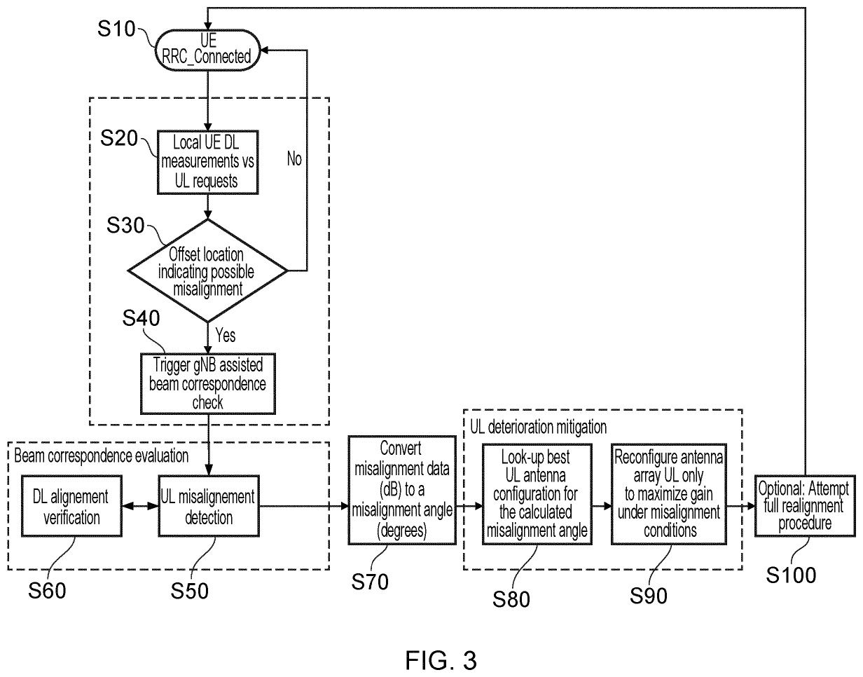

FIG. 3 is a flowchart showing the main processing steps performed by the user equipment;

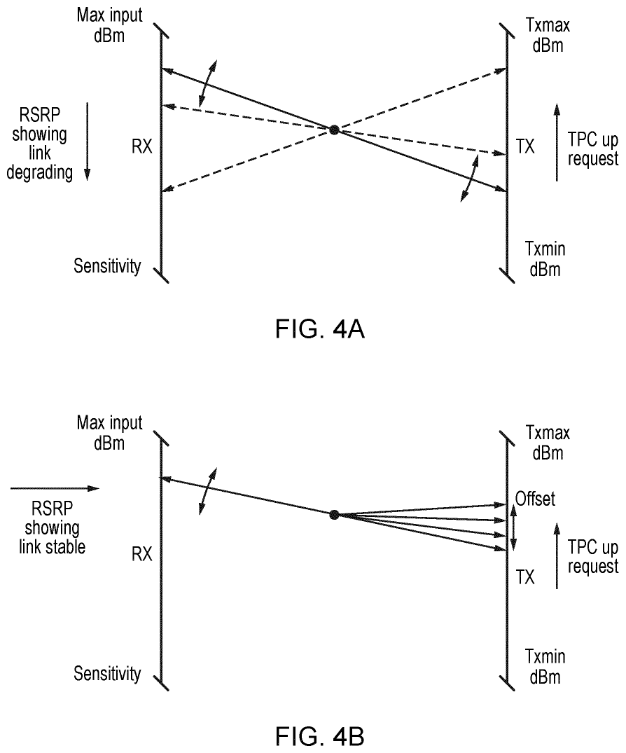

FIGS. 4A and 4B illustrate schematically the relationship between uplink and downlink conditions;

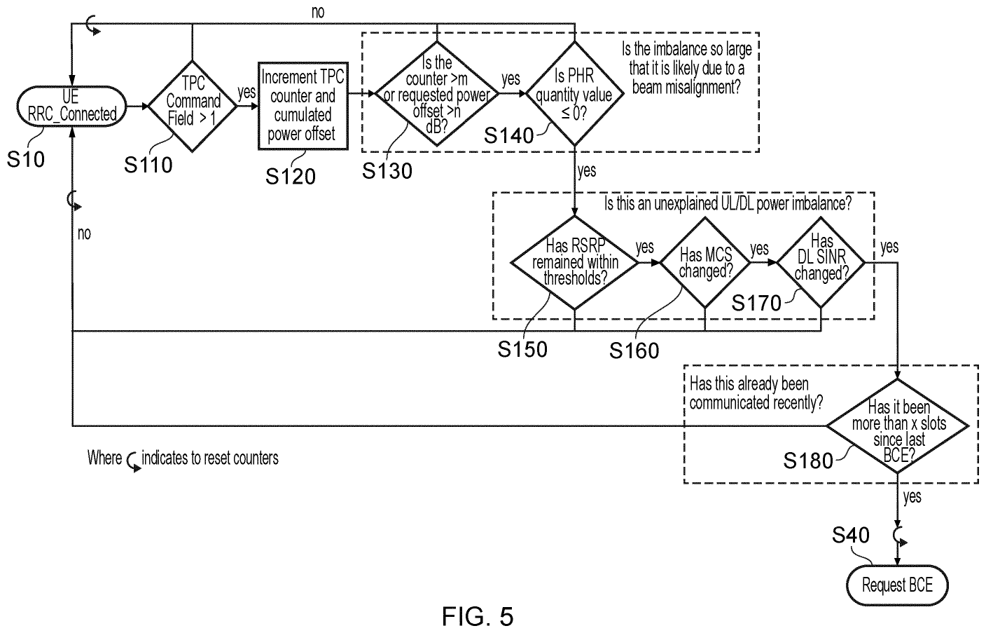

FIG. 5 illustrates in more detail one example implementation; and

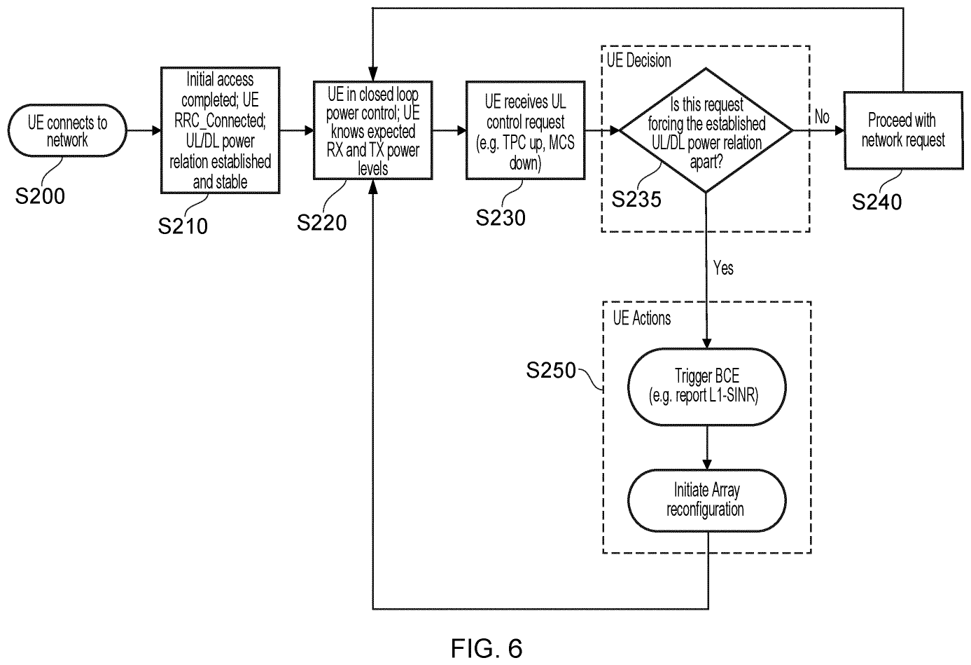

FIG. 6 illustrates in overview an example operation of the user equipment.

### DETAILED DESCRIPTION

Before discussing the example embodiments in any more detail, first an overview will be provided. Some embodiments provide a user equipment technique for the autonomous detection of uplink and downlink beam misalignment. Once stable power control has been achieved, the user equipment interprets uplink and downlink evaluation parameters, decides if a reconfiguration or realignment is needed and, if so, requests that reconfiguration or realignment. This enables the user equipment to autonomously trigger the reconfiguration or realignment which ensures that such reconfiguration or realignment is only requested when required, which saves on network overheads and ultimately improves throughput. In particular, the user equipment uses information such as channel parameters about its current operating state or condition and from these is able to make an assessment of whether reciprocal channel conditions should occur, where changes in the link quality are reflected in both uplink and downlink. Many different channel parameters like Reference Signal Received Power (RSRP), Modulation Coding Scheme (MCS) and Signal to Noise and Interference Ratio (SINR) and the like are aimed at adapting the link to the current channel conditions. These channel parameters are utilized by the user equipment to identify when the channel conditions are no longer reciprocal, which may indicate that a beam misalignment has occurred and indicate that a reconfiguration or realignment is needed to be triggered.

Uplink Beam Misalignment

FIGS. 1A, 1B and 1C illustrates uplink/downlink beam correspondence and misalignment. A gNB 10 has an uplink beam 15 (over which transmissions from a user equipment 10 are received) and a downlink beam 17 (over which transmissions to the user equipment 10 are transmitted). The user equipment 20 has an uplink beam 25 (over which transmissions from the user equipment 10 are transmitted) and a downlink beam 27 (over which transmissions to the user equipment 10 are received).

As can be seen in FIG. 1A, the uplink beam 25 and the downlink beam 27 are in correspondence (meaning that they are aligned and parallel) and they are directed towards the corresponding uplink beam 15 and downlink beam 17.

As can be seen in FIG. 1B, the beam correspondence of the user equipment is preserved because the uplink beam 25 and downlink beam 27 are still aligned and parallel but now they are not directed towards the corresponding uplink beam 15 and downlink beam 17, which results in a suboptimal downlink and uplink with a similar reduced gain on both uplink and downlink.

FIG. 1C illustrates a misalignment between the uplink beam 25 and the downlink beam 27 because the uplink beam 25 and downlink beam 27 are no longer aligned and parallel but now the uplink beam 25 and downlink beam 27 diverge by an angle A. This misalignment can occur for a variety of reasons and can occur dynamically in the field due to, for example, impedance variation of power amplifiers, low noise amplifiers and/or switches which are affected by temperature, design tolerances, power levels of operation (which can cause small shifts), as well as power imbalances. In particular, a mismatch towards the antenna and/or towards one or more amplifier can affect the uplink and downlink directivity, whereby the beams will exhibit a different directivity towards the gNB 10. It will be appreciated that this is not limited to such occurrences and could include any type of unwanted variance of radio-frequency (RF) performance with any component(s) associated with the antenna control circuitry, receiver chain(s) and transmitter chain(s). Furthermore, if the direction of the uplink beam 25 does not correspond with the downlink beam 27 then power is not ultimately received at the gNB 10. The problem of beam misalignment is less severe for the gNB 10 than it is for the user equipment 20. This is because the freedom allocated for antenna design on the gNB 10 is significantly higher than on the user equipment 20, where the mmWave antenna arrays will have to share volume with other electrical components and antenna(s) for sub-6 GHz communication. Moreover, the user equipment 20 have a large number of constraints such as, for example, supporting a very large bandwidth for worldwide coverage, and they are often implemented with more cost-effective embedded components, thus compromising tolerance levels and resulting in impedance variations across different operational settings. Thus, the impedance (input and/or output impedance) of one or more electronic component or module within the receive and transmit chains may change and change differently across different power and gain settings which means that even balancing out the impact of any impedance mismatch helps little as the user equipment 20 adapts the closed loop power regulation of the gNB 10.

Hence, uplink/downlink beam correspondence is preserved if: Identical antenna element weights used for uplink and downlink results in identical beam gain and direction for uplink and downlink; Antenna element weights can be offset by pre-characterized values to obtain identical beam gain and direction for uplink and downlink; Two “codebooks” of beam weight vectors have been established, one for uplink and a second for downlink. Each beam weight vector in the uplink codebook is paired 1-1 with a beam weight vector in the downlink codebook such that the paired uplink and downlink beam weight vectors have identical beam and gain directions. If these are not fulfilled, then beam correspondence is broken and the uplink will be misaligned as depicted in FIG. 1C.

The impedance mismatches within the user equipment 20 can be seen in more detail in FIG. 2 which is a transmit and receive simplified block diagram of the user equipment 20 showing the different impedances towards the low noise amplifier and the power amplifier. It will be appreciated that as well as input impedance mismatches, there can be output impedance mismatches between components or modules and this difference between output and input impedances can affect power transfer between these components or modules at the frequency(ies) of interest. The impedances at the individual antenna elements in the antenna array Zant will change as a function of the required frequency and the configured angular direction of the main beam. As such, each antenna element will exhibit different impedances at any given time, which will affect the performance of the individual power amplifier(s) PA and low noise amplifier(s) LNA connected to that specific antenna element. A power amplifier is generally much more sensitive to changes in load impedances than a low noise amplifier, so the effects of the power amplifier load impedance changes are not captured in the beam alignment procedures, since they rely on downlink only, but as part of the calibration or configuration of the transmission beam control and configuration that secures the reception and transmission beam directions are aligned upon calibration/configuration. In addition, the power amplifier misbehaviours are not only caused by the changes in load impedances but also power amplifier related factors like output power level, ambient temperature and potential gain modes. So, the actual radiation pattern formed by the antenna array will be affected by these different power amplifier and low noise amplifier misbehaviours and result in different radiation patterns for downlink and uplink, even with identical array configuration (weights). These differences in the radiation patterns can be insignificant for some array/RF front end configurations (boresight at low power) but be severe for other configurations (angular steered direction at high power) and result in beam non-correspondence, when configuration or calibration is insufficient for the state of the circuit.

User Equipment Operation

FIG. 3 is a flowchart showing the main processing steps performed by the user equipment 20.

At block S10, the user equipment 20 determines whether it is in RRC_connected mode, where RRC is Radio Resource Control. If it is, then processing proceeds to block S20.

At block S20, the user equipment 20 compares downlink channel performance measurements and compares these against uplink channel reconfiguration requests, as will be described in more detail below, processing then proceeds to block S30.

At block S30, a determination is made as to whether there is an offset which indicates that the channels are no longer reciprocal and so the misalignment may occur.

Reciprocal and Non-Reciprocal

FIGS. 4A and 4B illustrate schematically the relationship between uplink and downlink conditions, which illustrate reciprocal and nonreciprocal conditions which indicate possible misalignment as determined at block S30 mentioned above. As shown in FIG. 4A, when the user equipment measures a drop in RSRP and receives a Transmit Power Control (TPC) command to increase the transmit power, it infers that the channel has deteriorated due to, for example, a blocking object in the line of sight path, a user equipment rotation, a user interaction with the UE, etc. For example, the RSRP may indicate a drop of 3 dB and the TPC command may indicate a corresponding increase in transmission power of 3 dB. The user equipment 20 can therefore determine that there is a reciprocal relationship and that the uplink and downlink power relationship is stable. Although in this example the downlink channel performance is indicated by RSRP, it will be appreciated that any other channel performance parameter may also be used such as, for example and not limited to, a downlink signal strength, a downlink signal power, a downlink signal quality, a downlink channel quality and a downlink rank indicator. Likewise, although this example uses the TPC command as an indication of the uplink channel reconfiguration, it will be appreciated that other indications may be used such as, for example, a request to increase uplink transmission power and a request to change an uplink modulation scheme and the like.

However, as can be seen in FIG. 4B, a situation can occur where there is a nonreciprocal change in uplink and downlink performance and the uplink/downlink power relation is unstable. For example, when the user equipment 20 measures a stable downlink (for example, the RSRP remains unchanged but the user equipment 20 receives a TPC command to change uplink power, then assuming that there are no other configuration changes that the user equipment is aware of, then the user equipment 20 will determine that there is an uplink downlink nonreciprocal relationship (i.e. an unexplained uplink/downlink power imbalance) that is likely to be an unintended beam tilt due to an unpredictable situation of beam non-correspondence, resulting in possible beam misalignment. In other words, the downlink beam 25 and the uplink beam 27 at the user equipment 20 does not exhibit the same radiation pattern and may cause a sub-optimal gain on the uplink only. When the requested transmission power is offset to the expected transmission power (corresponding to the reception power), the user equipment will consider the beam non-correspondence as an alternative to hardware failure which is the typical interpretation in such a scenario.

The user equipment 20 correlates a downlink measurement to an uplink request. In the above, the downlink measurement is for example an RSRP measure and the uplink request is a TPC Command to increase power. It will be appreciated that embodiments are not restricted to these specific measures, as the downlink measurement could also be, for example, an SINR measure and the uplink request could be, for example, a change in Modulation Coding Scheme (MCS). Other metrics are not precluded.

The user equipment 20 decision mechanism to trigger beam correspondence evaluation is:
if the gNB 10 repeatedly requests the user equipment 20 to increase its transmit power (or decreasing the MCS as another embodiment),
while the user equipment 20 knows that there are no local changes to the user equipment 20 and that RSRP/MCS has not changed either (or SINR has not changed as another embodiment),
then, the user equipment 20 concludes that this unusual behaviour is likely to be caused by a beam misalignment. Therefore, it autonomously initiates a beam correspondence evaluation.

The user equipment 20 decision mechanism can be summarised as follows:

If TPC Command Field>1 & RSRP stable=>trigger beam correspondence evaluation

If TPC Command Field>1 & RSRP decreased=>do not trigger beam correspondence evaluation

Thresholds and counters may be part of the triggering decision, as explained in more detail below.

TPC Command Field>1 means increase power at the user equipment 20.

Note that in the above example for the user equipment 20 decision mechanism, the gNB reaction to uplink deterioration is through a TPC Command to request to increase the uplink power. However, this user equipment 20 method to trigger beam correspondence evaluation is also valid if the gNB 10 action was to decrease the modulation index (MCS) for example while RSRP remains stable. That is to say, this method can be generalized to correlating unexpected uplink requests (e.g. metrics on power, modulation, etc.) with reference to downlink measurements (e.g. metrics on power, interference, etc.) and user equipment 20 a-priori knowledge (e.g. load mismatch detection), thus implying non-reciprocal channel conditions.

If no misalignment is indicated then processing returns to block S10.

Triggering

If a misalignment is indicated then processing proceeds to block S40 where a gNB 10 assisted beam correspondence check is triggered. Hence, the user equipment 20 may trigger the beam correspondence check at S40 and request that the misalignment is corrected autonomously, using information already available to the user equipment 20. In some situations, the gNB 10 may have requested the TPC for a specific reason (for example, a gNB panel split). In such situations it can choose to ignore the user equipment beam correspondence evaluation request and processing may return to block S10.

Processing then proceeds to block S50 where a beam correspondence evaluation occurs using uplink misalignment detection and/or through downlink alignment verification at block S60. The beam correspondence evaluation may be performed through Sounding Reference Signal (SRS) sweeps. The beam correspondence evaluation may be initiated by the UE reporting L1 SINR which is the user equipment 20 action that initiates the beam correspondence evaluation and/or beam realignment. Processing then proceed to block S70.

At block S70, the misalignment data between the uplink and the downlink beams is converted to a misalignment angle and at block S80, a revised uplink antenna configuration is determined for the misalignment angle and processing proceeds to block S90 where the antenna array is reconfigured to improve gain under the misalignment conditions.

For example, after the user equipment 20 has decided to trigger beam correspondence evaluation, an example of user equipment 20 action may be as follows:

1. Request beam correspondence evaluation—for example, report L1-SINR (using existing signalling) to request SRS UL sweep, and/or trigger uplink misalignment detection.

2. Reconfigure array—for example, optimize the user equipment 20 uplink pattern to mitigate degradation and avoid radio link failure until beam realignment can be performed.

Furthermore, if the user equipment 20 already knows it has no means for beam realignment, an alternative user equipment 20 action is to:

1. Request downlink verification to have/update the reference—for example, send Channel State Information-Reference Signal (CSI-RS) repetition request (using existing signalling) to trigger DL verification.

2. Reconfigure array—for example, optimize the user equipment 20 uplink pattern to mitigate degradation and avoid radio link failure until beam realignment can be performed.

Note that the order of the actions is interchangeable.

Processing then proceeds to block S100.

Optionally, at block S100 should the antenna array reconfiguration not sufficiently improve the alignment between the uplink and the downlink beams then a full realignment procedure is initiated and processing returns to block S10.

Thresholds and Counters

FIG. 5 illustrates in more detail one example implementation of blocks S10 to S40. This implementation utilizes thresholds and counters in the user equipment 20 decision mechanism to avoid unnecessarily triggering a beam correspondence evaluation process. For example, the user equipment 20 will not trigger a beam correspondence evaluation after only a single TPC Command that does not match the expected transmission power but after the requested transmission power is n dB above the expected transmission power level, i.e. the offset is larger than n dB. The user equipment 20 can define an evaluation threshold for triggering beam correspondence evaluation based on power levels as follows:

Offset=requested transmission power−expected transmission power.

Applying this threshold to the user equipment 20 decision mechanism would look like the following:

If Offset>n dB & RSRP stable=>trigger beam correspondence evaluation

Moreover, the evaluation metric is not necessarily on absolute power levels but can also be on a number m of consecutive TPC Commands requiring to, for example, increase power. Applying this counter to user equipment 20 decision mechanism would look like the following:

If #(TPC Command Field>1)>m & RSRP stable=>trigger beam correspondence evaluation

Finally, to avoid consecutive requests from the user equipment 20, a timer limiting the number of requests to x requests per frames can be considered. The user equipment 20 decision mechanism taking power offset, counter and timer is explained in more detail below. All the aforementioned parameters can be user equipment 20 specific or configured by the network. They may reset after a single or a given number of beam correspondence evaluation requests.

Hence, at block S10, the user equipment 20 determines whether it is in connected mode.

Processing then proceeds to block S110.

At block S110, it is determined whether the TPC command field is greater than one. If not, then the counters are reset and processing returns to block S10.

If there is a TPC command, then processing proceeds to block S120 where the TPC counter and the cumulative power offset is incremented.

Processing then proceeds to block S130 where it is determined whether the TPC counter is greater than the threshold amount n or whether the cumulative requested power offset is greater than a threshold m. If not, then the counters are reset and processing returns to block Si.

If either of these conditions is true, then processing proceeds to block S140 where it is determined whether the power headroom quantity of the power headroom report (PHR) has a value less than or equal to zero. If not, then the counters are reset and processing returns to block S10.

If this condition is met, then processing proceeds to block S150 where it is determined whether the mismatch is due to an unexplained uplink downlink power imbalance. In particular, a determination is made as to whether RSRP has remained within thresholds. If not, then the counters are reset and processing returns to block S10.

If this condition is met, then processing proceeds to block S160 where it is determined whether the MCS has changed. If the MCS has not changed, then the counters are reset and processing returns to block S10.

If this condition is met, then processing proceeds to block S170 where it is determined whether the downlink SINR has changed. If not, then the counters are reset and processing returns to block S10.

If this condition is met, then processing proceeds to block S180 where it is determined whether a beam correspondence evaluation has been requested recently. In particular, it is determined whether more than a threshold number of slots have passed since the last beam correspondence evaluation. If not, then the counters are reset and processing returns to block S10.

If this condition is met, then the counters are reset and processing proceeds to block S40 where a beam correspondence evaluation is requested.

Uplink Power Control

Uplink power control is done in one of two ways, depending on if the user equipment 20 is in idle or in connected mode: open or closed loop. The user equipment 20 uses open loop for the Physical Random Access Channel (PRACH) under initial access (i.e. PRACH msg1 power ramping). Thereafter, the user equipment 20 is in closed loop (e.g. TPC Command in the Re-Authorization Request (RAR)). The gNB 10 corrects the power offset from the open loop transmission estimate on the user equipment 20. The gNB 10 might issue TPC commands that do not relate to a RSRP change, only to settle the initial uplink/downlink power relationship. Note that a beam correspondence evaluation should not be triggered based on these early TPC Commands relating to initial access. It is only after P3 is completed and the uplink/downlink power relation settles to become reciprocal, and the user equipment 20 can use this uplink/downlink reciprocal balance for the beam correspondence evaluation trigger (including thresholds and counters). Hence, only after the TPC<->RSRP relation settles (i.e. after P3 beam alignment is complete and power relation has settled) can the user equipment 20 interpret non-reciprocal channel conditions and trigger beam correspondence evaluation when detecting a broken power relation between uplink/downlink.

Summing up, preconditions for using the trigger are:

1. Closed loop power control, and

2. UL/DL relation settled.

TPC Commands within RAR during initial access and in RRC_Connected mode are detailed table 1. The field TPC command relates to how much power should be reduced or increased for user equipment 20 transmission.

TABLE 1
TPC commands (38.213 v2.0.0 - Table 7.1.1-1: Mapping of
TPC Command Field in Downlink Control Information (DCI))

| TPC Command | Accumulated δ_{PUSCHb, f, c} | Absolute δ_{PUSCHb, f, c} |
|---|---|---|
| Field | or δ_{SRSb, f, c} [dB] | or δ_{SRSb, f, c} [dB] |
| 0 | −1 | −4 |
| 1 | 0 | −1 |
| 2 | 1 | 1 |
| 3 | 3 | 4 |

UE Action Overview

FIG. 6 illustrates in overview an example operation of the user equipment 20.

At block S200, the user equipment connects to the network. Processing proceeds to block S210.

At block S210, the initial access completes, the user equipment 20 is in the RRC_connected state (see block S10 above) and the uplink/downlink power relationship is stable. Processing proceeds to block S220.

At block S220, the user equipment 20 moves to closed loop power control and the user equipment 20 knows the expected transmission and reception power levels which are expected to be reciprocal as illustrated in FIG. 4A above. Processing proceeds to block S230.

At block S230, the user equipment 20 receives an uplink control request. Processing proceeds to block S235.

At block S235, the user equipment 20 determines whether a non-reciprocal power relationship is occurring as illustrated in FIG. 4B and described in blocks S20 to S40 and S110 to S180 above. If not, then processing proceeds to block S240 where the uplink control request is processed. If a non-reciprocal power relationship is occurring, then processing proceeds to block S250 where actions are taken such as those described in blocks S50 to S100 above.

Note that in the example above, the first user equipment 20 action is to request Channel State Information Reference Signal (CSI-RS) repetition, the steps following that can be as specified or could be other messages depending future implementation (e.g. with Synchronization Signal/Physical broadcast channel (PBCH) block (SSB) repetition and Sounding Reference Signal (SRS) signals).

Furthermore, the order of the user equipment 20 actions could be reversed (e.g. first reconfigure array and then initiate beam correspondence evaluation) as the misalignment might be so severe that the priority is to avoid radio link failure. The user equipment 20 or the gNB 10 might also choose to skip the downlink verification (if, for example, it is judged that a previous measurement is still valid), then user equipment 20 would directly trigger beam correspondence evaluation. Similarly, the user equipment 20 could choose to skip downlink verification and beam correspondence evaluation altogether (for example, if it knows it cannot realign anyway) and directly trigger the array reconfiguration.

Some advantages of triggering beam correspondence evaluation based on uplink/downlink power relationship breaking apart (non-reciprocal correspondence) are as follows:
Saves overhead and improves throughput (compared to triggering beam correspondence evaluation on every PA or codebook change or in a periodic manner; beam correspondence evaluation is only triggered when there is a real risk)
Provides an autonomous user equipment 20 trigger, i.e. beam correspondence evaluation is triggered based on the user equipment parameters
Going through with TPC Commands to increase transmission power when misaligned will cause large cell interference, it is a much better solution to trigger a beam correspondence evaluation.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. A person of skill in the art would also recognize that the illustration of a specific order of blocks does not necessarily imply that there is a required or preferred order for the blocks and that the order may be varied. A person of skill in the art would furthermore recognize that it may be possible to omit a block or blocks.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method, comprising:
receiving, at a user equipment, channel parameters relating an uplink channel and a downlink channel;
determining, at said user equipment, from said channel parameters whether there is a mismatch in uplink channel and downlink channel performance; and
in response to determining that there is a mismatch in uplink channel and downlink channel performance, triggering, at said user equipment, a user equipment beam reconfiguration procedure.

2. The method of claim 1, wherein said triggering comprises triggering, at said user equipment, at least one of: an uplink beam and a downlink beam reconfiguration; and an uplink beam and a downlink beam realignment procedure.

3. The method of claim 1, wherein at least one channel parameter comprises at least one of an indication of an uplink channel reconfiguration; and an indication of a downlink channel performance.

4. The method of claim 1, wherein said determining comprises at least one of: determining that there is said mismatch when said channel parameters indicate a request to reconfigure said uplink channel to increase performance of said uplink channel in an absence of an indication of a corresponding decrease in performance of said downlink channel; determining that there is said mismatch when said channel parameters indicate said request to reconfigure said uplink channel to increase performance of said uplink channel by a first amount in said absence of said indication of said corresponding decrease in performance of said downlink channel by at least said first amount; and determining that there is said mismatch when said channel parameters indicate said request to reconfigure said uplink channel to increase performance of said uplink channel by said first amount in said absence of said indication of said corresponding decrease in performance of said downlink channel by a threshold amount greater than said first amount.

5. The method of claim 4, comprising varying said threshold amount based on uplink channel reconfigurations made by said user equipment.

6. The method of claim 4, comprising receiving an indication of said threshold amount from a network node.

7. The method of claim 1, wherein said determining comprises determining that there is said mismatch when said channel parameters indicate said request to reconfigure said uplink channel to increase performance of said uplink channel by said first amount in said absence of said indication of said corresponding decrease in performance of said downlink channel by greater than said first amount over a period of time.

8. The method of claim 7, wherein said period of time is indicated by at least one of a counter, a timer and a number of transmission frames.

9. The method of claim 7, comprising receiving an indication of said period of time from a network node.

10. The method of claim 4, wherein said request to reconfigure said uplink channel comprises at least one of a request to increase an uplink transmission power and a request change to an uplink modulation scheme.

11. The method of claim 3, wherein said indication of said downlink channel performance comprises an indication of at least one of a downlink signal strength, a downlink signal power, a downlink signal quality, a downlink channel quality and a downlink rank indicator.

12. The method claim 1, comprising preventing said triggering during at least one of an uplink and a downlink reconfiguration procedure; a user equipment initial access procedure; an open loop power control procedure; prior to completing a user equipment beam alignment procedure; and prior to completing a P3 beam alignment procedure.

13. The method of claim 1, wherein said uplink beam and downlink beam realignment procedure comprises at least one of a beam correspondence evaluation procedure and an array reconfiguration.

14. A program storage device storing a computer program comprising instructions for causing an apparatus to perform at least the following:
receiving, at said apparatus comprising a user equipment, channel parameters relating an uplink channel and a downlink channel;
determining, at the user equipment, from the channel parameters whether there is a mismatch in uplink channel and downlink channel performance; and
in response to determining that there is a mismatch in uplink channel and downlink channel performance, triggering, at the user equipment, a user equipment beam reconfiguration procedure.

15. An apparatus, comprising:
means for receiving, at said apparatus comprising a user equipment, channel parameters relating an uplink channel and a downlink channel;
means for determining, at said user equipment, from said channel parameters whether there is a mismatch in uplink channel and downlink channel performance; and
means for triggering, at said user equipment and in response to determining that there is a mismatch in uplink channel and downlink channel performance, a user equipment beam reconfiguration procedure responsive to the means for determining said mismatch.

16. The apparatus of claim 15, wherein the means for triggering triggers, at said user equipment, at least one of: an uplink beam and a downlink beam reconfiguration; and an uplink beam and a downlink beam realignment procedure.

17. The apparatus of claim 15, wherein at least one channel parameter comprises at least one of: an indication of an uplink channel reconfiguration; and an indication of a downlink channel performance.

18. The apparatus of claim 15, wherein said means for determining comprises at least one of: determining that there is said mismatch when said channel parameters indicate a request to reconfigure said uplink channel to increase performance of said uplink channel in an absence of an indication of a corresponding decrease in performance of said downlink channel; determining that there is said mismatch when said channel parameters indicate said request to reconfigure said uplink channel to increase performance of said uplink channel by a first amount in said absence of said indication of said corresponding decrease in performance of said downlink channel by at least said first amount; and determining that there is said mismatch when said channel parameters indicate said request to reconfigure said uplink channel to increase performance of said uplink channel by said first amount in said absence of said indication of said corresponding decrease in performance of said downlink channel by a threshold amount greater than said first amount.

19. The apparatus of claim 18, comprising means for varying said threshold amount based on uplink channel reconfigurations made by said user equipment.

20. The apparatus of claim 18, comprising means for receiving an indication of said threshold amount from a network node.
